(19) United States
(12) Patent Application Publication
(10) Pub. No.: US 2010/0223190 A1
(43) Pub. Date: Sep. 2, 2010

(54) METHODS AND SYSTEMS FOR OPERATING A VIRTUAL NETWORK OPERATIONS CENTER

(76) Inventors: Sean Michael Pedersen, San Jose, CA (US); Katherine Barker, Englewood, CO (US); Joel Michael Cook, Fremont, NE (US)

Correspondence Address: SCHWEGMAN, LUNDBERG & WOESSNER/EBAY, P.O. BOX 2938, MINNEAPOLIS, MN, 55402, US

(21) Appl. No.: 12/714,045

(22) Filed: Feb. 26, 2010

Related U.S. Application Data
(60) Provisional application No. 61/156,383, filed on Feb. 27, 2009.

(51) Int. Cl. G06Q 10/00; G06F 3/01

(52) U.S. Cl. 705/305; 705/345; 715/758

(57) ABSTRACT

Methods and systems for operating a virtual network operations center are described. In one embodiment, a data processing module receives data from an initial user regarding an incident or outage. A collaboration module enables collaboration between the initial user and at least one additional user in resolving the incident or outage during a collaborative session. A paging module pages at least one additional user to the collaborative session. An incident reporting module provides an incident report. A problem ticket module provides a problem ticket. An action item module provides one or more action items. Additional methods and systems are also disclosed.

### CROSS-REFERENCE TO RELATED APPLICATIONS

This application claims the benefit of priority to U.S. Provisional Application No. 61/156,383, filed Feb. 27, 2009, entitled “Methods and Systems for Operating a Virtual Network Operations Center” which is incorporated herein by reference in its entirety.

### BACKGROUND

Network operation centers are used by companies to handle outages and service interruptions for support systems. A variety of reports and tickets are individually created and used to resolve and track outages, service interruptions and other problems.

### BRIEF DESCRIPTION OF THE DRAWINGS

Some embodiments are illustrated by way of example and not limitation in the figures of the accompanying drawings in which:

FIG. 1 is a block diagram of a system for operating a virtual network operations center, according to an example embodiment.

FIG. 2 is a block diagram of an incident response tool that may be deployed within the virtual network operations server of FIG. 1, according to an example embodiment.

FIG. 3 is a block diagram of the components of a virtual network operations center session, according to an example embodiment.

FIG. 4A is a process diagram illustrating a method for processing a new incident, according to an example embodiment.

FIG. 4B is a flow chart describing the lifecycle of an incident within the VNOC system, according to an example embodiment.

FIG. 5 is a screenshot of a site operations ticket, according to an example embodiment.

FIG. 6 is a screenshot of a system resolution report, according to an example embodiment.

FIGS. 7 and 8 are screenshots of user interfaces for the incident response tool of FIG. 3, according to an example embodiment.

FIG. 9 is a screenshot of an action item ticket, according to an example embodiment.

FIG. 10 is a screenshot of a master repair ticket, according to an example embodiment.

FIG. 11 is a block diagram of a machine in the example form of a computer system within which a set of instructions for causing the machine to perform one or more of the methodologies discussed herein.

### DETAILED DESCRIPTION

Example methods and systems for operating a virtual network operations center are described. In the following description, for purposes of explanation, numerous specific details are set forth in order to provide a thorough understanding of example embodiments. It will be evident, however, to one of ordinary skill in the art that embodiments of the invention may be practiced without these specific details. As used herein, the term “or” may be construed in an inclusive and exclusive sense.

In conventional network operations centers, when a service outage or incident occurs, a network operations center and associated teams work to resolve the incident. Teams may collaborate over the phone, but oftentimes a network operations center is a centralized physical location. A network operations center may act as a hub to oversee the operations and functionality of systems.

A ticket may be a file that contains information about a particular issue, problem or action which may resolve or describe an incident. Tickets are often used to record information and track progress. In the process of addressing an incident, individual tickets may be manually created, updated and closed to track incidents, problems and action items.

However, the incidents that arise may involve multiple teams which are oftentimes staffed at disparate locations, time zones, and linguistic localities. Operating a physical network operations center may prove difficult when key parties speak with different accents, live in different time zones, possess varying degrees of familiarity with the affected systems and may join the incident resolution effort at different stages. Accents may frustrate voice communications, people living in different time zones may make it difficult to discuss and perform key tasks as a group, disaggregated information makes it harder to understand the incident and the incident resolution process may need to be interrupted to provide status or update new team members. In addition, a single incident may spawn multiple tickets and reports whose relations to each other may not be easily viewed. The process of reporting incidents and tickets may also duplicate work. Thus, a network operations center should provide a central hub through which disparate teams can communicate effectively and a single repository where information related to an incident can be retrieved and delivered.

A virtual network operations center (VNOC) can provide a single hub accessible to all teams with network access. The VNOC may provide benefits such as enabling online chat and phone bridges, recording the chat and phone bridge data, maintaining a record of such communications, and associating the communications data with the incident, so that others may search for and review the data at a later time. In addition, the VNOC may also maintain a data repository of ancillary data, such as past incidents and provide supplemental knowledge management. The VNOC may provide a more complete historical record of an incident by displaying the prior VNOC sessions of similar past incidents and their associated tickets. It may also provide additional information about the affected system and provide system status. In an example embodiment, a VNOC may automatically populate, generate and explicitly associate tickets with an incident, and tickets with each other to provide a rich contextual background of the issue. The process to create tickets and enter incident data can also be centralized to the VNOC.

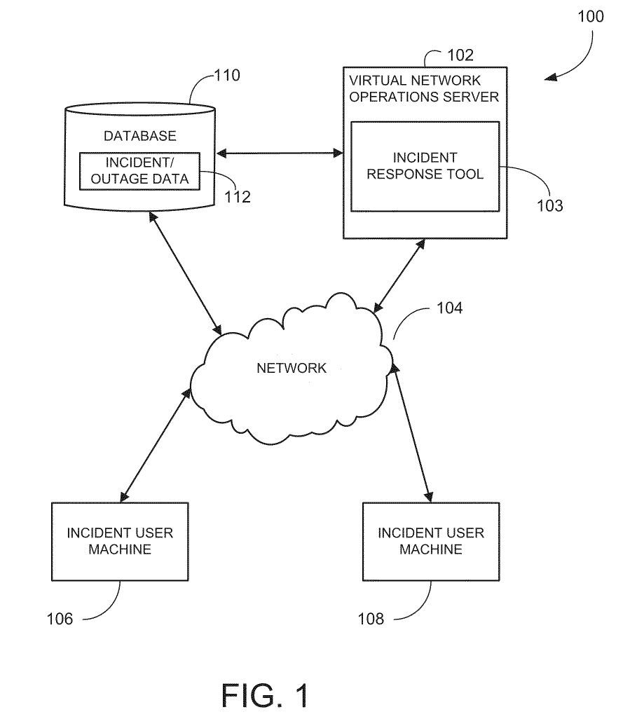

FIG. 1 illustrates an example system 100 in which one or more users may communicate over a network 104, such as the internet, an intranet, or a communications network, with a virtual network operations server 102 using one or more incident user machines 106, 108 to collaborate regarding an incident or outage in one or more systems. The network operations server 102 is a server that acts as a hub for collaboration and hosts an incident response tool 103. The network operations server 102 and the incident response tool 103 may be operated by an entity associated with or responsible for the support systems in which the incident or outage has occurred. The network operations server 102 and the incident response tool 103 together may comprise a VNOC. The incident response tool 103 provides a collaborative medium that allows multiple users, technicians, and managers to view the current status of an incident or outage in progress. The incident response tool 103 may capture an associated chat and telephone calls and makes the communications available to other users with access to the incident response tool 103 during the incident or outage. The communications are then recorded so that it can be reviewed later.

The incident response tool 103 may create, auto populate, and associate various incident, problem, and change related forms and tickets. The incident response tool 103 also provides for better and easier managing of metrics information. Data presented by the incident response tool 103 may be fetched from a database 110 that hosts incident/outage data 112 or be transmitted from an incident user machine 106, 108.

The incident response tool 103 operates as a collaborative tool that facilitates quicker and easier resolution of incidents or outages through improved communication, even across time zones and language barriers. The incident response tool 103 also allows management to stay informed as to the status of the incident or outage without interrupting a call between teams attempting to resolve the incident or outage to ask for an update. The incident response tool 103 allows for more comprehensive data collection for metrics.

The incident response tool 103 may be used to receive information that is used to populate an incident ticket, a problem ticket, and an action ticket with initial information. The incident response tool 103 may store user input in the database 110. Once the initial information is provided, subsequent updates to the information received by the incident response tool 103 may be reflected in the incident ticket, the problem ticket, and an action ticket. In some embodiments, the incident response tool 103 may preserve the initial information.

Examples of the incident user machines 106, 108 deployed in the system 100 include, but are not limited to, a gaming console, a receiver card, a set-top box (STB), a mobile phone, a personal digital assistant (PDA), a display device, a generic computing system, a mobile computing device, or the like. Other devices may also be used.

The network operations server 102 may store incident/outage data 112 regarding the incident or outage, including associated tickets, in the database 110.

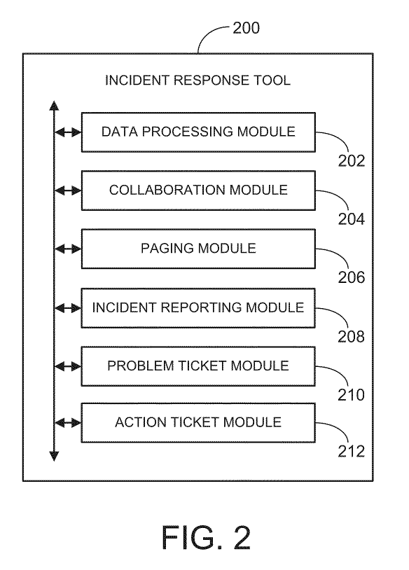

FIG. 2 is an example incident response tool 200 that may be deployed in the network operations server 102, or otherwise deployed in another system, according to an example embodiment. One or more modules are included in the incident response tool 200 to enable collaboration for resolving the incident or outage. The modules of the incident response tool 200 that may be included are a data processing module 202, a collaboration module 204, a paging module 206, an incident reporting module 208, a problem ticket module 210, and an action ticket module 212. Other modules may also be included.

Data is received regarding the incident or outage by the incident response tool 200 through the data processing module 202. The data received may include the identity of the affected system, the key parties for incident resolution, details about the incident or outage, and other information. The data processing module 202 may also query other sources for information, such as the database for information about the affected system or prior similar incidents. Once an initial session to resolve the incident or outage has been initiated, the key parties may collaborate in a session through the collaboration module 204. The collaboration module may facilitate collaboration by initiating a collaborative chat room or a phone bridge. The key parties may be paged to the session (e.g., by an initiating user) through the paging module 206. As an example, pages may be sent by phone call, pager, email message, text message or instant message.

Based on the results of the session, the incident reporting module 208 transmits or otherwise provides an incident report and incident ticket, the problem ticket module 210 transmits or otherwise provides a problem ticket, and the action item module 212 transmits or otherwise provides one or more action tickets. Further updates to a ticket are managed through their respective modules. The respective modules of may also associate their transmitted or provided tickets with related tickets, such as relating a problem ticket with the incident ticket that spawned it, and may populate some fields of their tickets with information received by the data processing module 202.

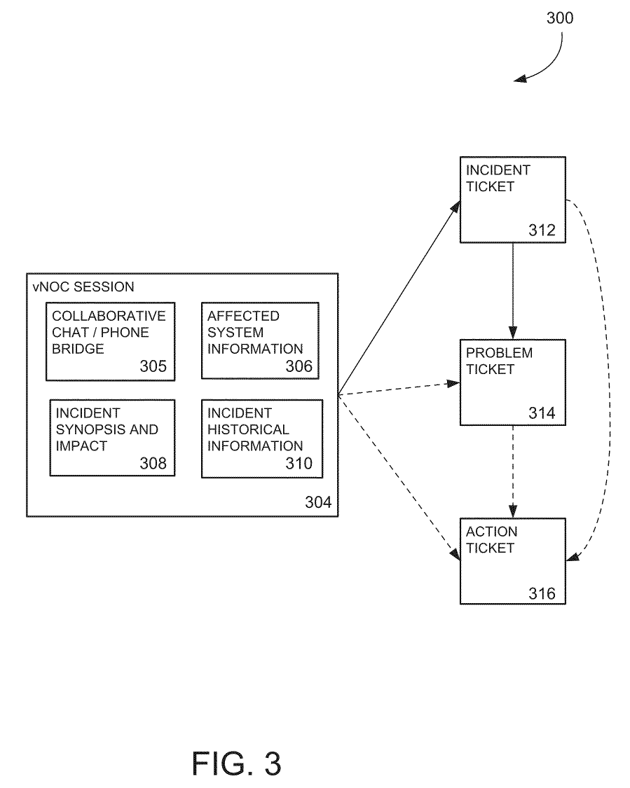

FIG. 3 is a block diagram of the components of a VNOC session 300, according to an example embodiment. A VNOC session 304 is an instantiation of the VNOC system in response to an incident or outage. The VNOC session 304 may be initiated, presented and managed through an incident response tool. The VNOC session 304 presents data related to an incident.

The VNOC session 304 may facilitate communications between parties. In an example embodiment, the VNOC session 304 spawns a collaborative chat or a phone bridge 305. The collaborative chat 305 may be a group chat program initiated on a webpage or through the incident response tool or a communications software application. The collaborative chat 305 may allow users of the VNOC session 304 to chat about the incident while maintaining a record of what was said, by whom and at what time. The collaborative chat 305 may allow multiple users to participate at the same time. The collaborative chat 305 also facilitates easier communications by supporting text chats when communicating parties may speak with regional accents. In an example embodiment, the VNOC session 304 may spawn a phone bridge 305, or a conference bridge, to allow users to call into a single shared phone bridge to conduct a conference call and to discuss the incident with voice data.

The VNOC session 304 may also display ancillary data, such as affected system information 306. The process initiating the VNOC session 304 includes data identifying the affected system. The VNOC session 304 presents affected system information 306, which may include static data, such as, but not limited to, information regarding physical machines, location and associated personnel. This may include the contact information for teams or individuals that own or have significant knowledge regarding affected systems. This data may be retrieved from the database. Dynamic data, such as real time or time delayed feedback about the operations of the system, may also be displayed, such as the current load on the servers, total number of users, or other metrics. This data may be fetched from the database or the system itself. Additionally, the affected system information 306 may include data about the incident. Such data may include the time the incident was reported, the number of affected users, the severity of the incident and other information.

The VNOC session 304 also presents an incident synopsis and impact 308. In an example embodiment, only a VNOC operator, or designated operators, may alter the incident synopsis and impact 308. The purpose of the incident synopsis and impact 308 is to provide an easily accessible status report of the incident. This allows teams of people working on the project to quickly view the VNOC session 304 and understand the current status and what work has been done without interrupting ongoing efforts. The incident synopsis and impact 308 may be manually entered or may be automatically updated in part or in whole. The incident synopsis and impact 308 may describe the initial incident and actions taken to resolve the incident. It may also include a description of a root cause and actions required to resolve the incident as well as a description of affected systems and the impact. This may include, but is not limited to, descriptions of the effects on end users and backend systems.

The VNOC session 304 may also present ancillary incident historical information 310. In an example embodiment, the VNOC session 304 may display information regarding similar prior incidents and display information that assists in the resolution of the current incident. Similar prior incidents may be, but are not limited to, incidents with similar descriptions, that affected similar systems or have similar root causes. The incident historical information 310 may include references to prior VNOC sessions, other tickets, or links to other sources of data relevant to the incident that spawned the VNOC session.

An incident ticket 312 is a ticket that describes the incident. An incident ticket 312 may describe effects, such as a power outage or delay in services, and other details, such when the power outage occurred and the effected systems. When a VNOC session 304 is initiated, it may automatically generate and populate relevant fields of the incident ticket 312. Later, the incident ticket 312 may be updated or altered by a VNOC operator to reflect the status or new information. A problem ticket 314 is created if a root cause of the incident is discovered. Examples of root causes may include, but are not limited to, a technical bug, a physical malfunction, or a process deficiency. In some instances, an incident may not spawn a problem ticket 314 because there was no underlying problem or the incident has since been resolved or addressed. An action ticket 316 is a ticket that represents and tracks the specific actions required to resolve a root problem associated with a problem ticket 314 or the effects described by an incident ticket 312. For example, an incident ticket 312 may show that a certain process has failed, the problem ticket 314 may show that the root case was a malfunctioning server and the action ticket 316 may track the action of replacing the server with a new one. In an example embodiment, a VNOC session 304 may spawn multiple incident tickets, problem tickets and action tickets 312, 314, 316. An action ticket 316 must be related to either a problem ticket 314 or an incident ticket 312, and a problem ticket 314 must be spawned from an incident ticket 312. The incident response tool may associate incident, problem and action tickets 312, 314, 316 when proper and present those relationships in the VNOC session 304.

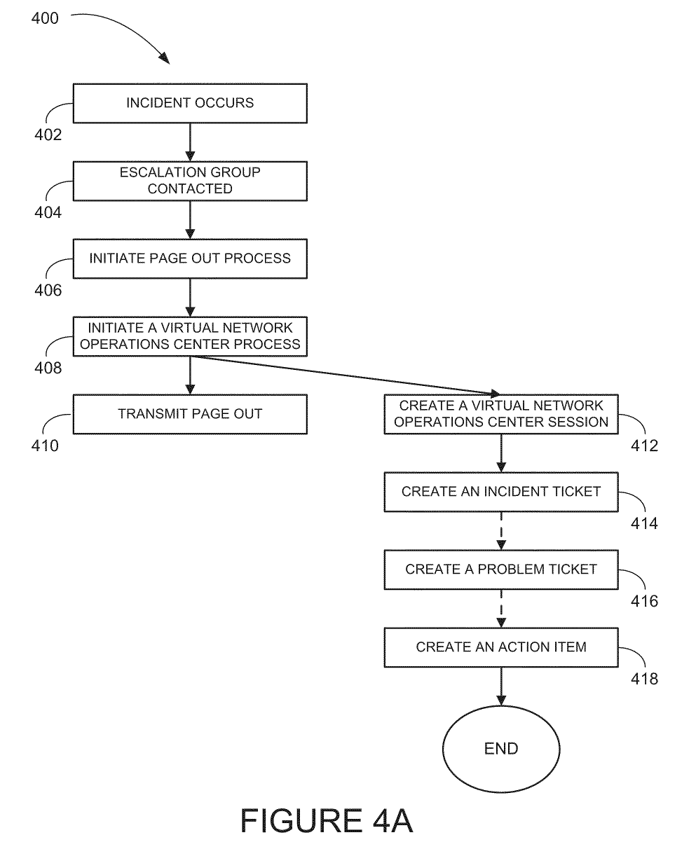

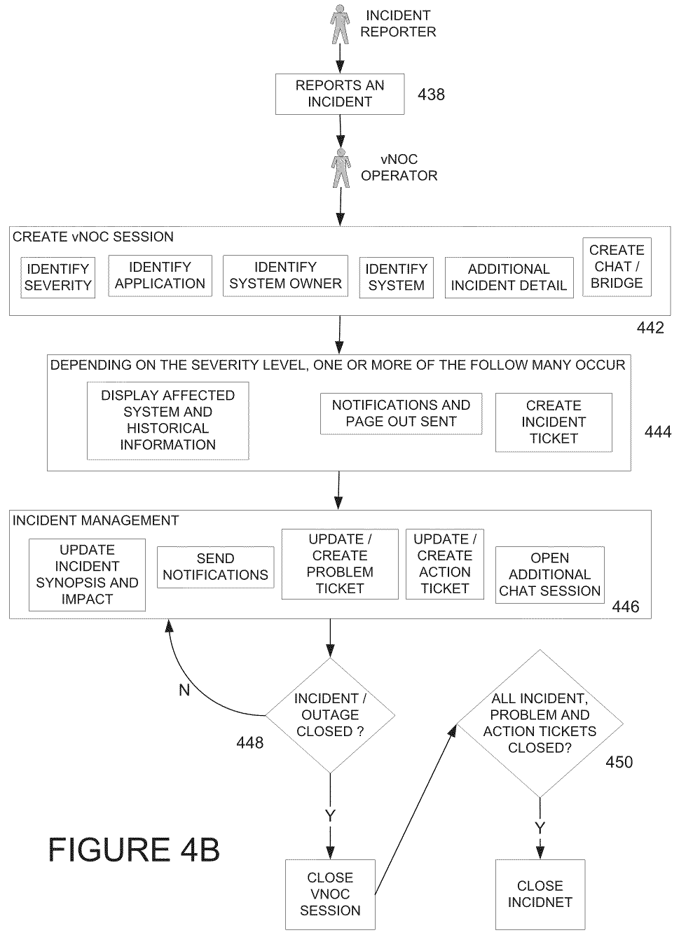

FIG. 4A is a process diagram illustrating a method 400 for processing a new incident, according to an example embodiment. The method 400 may be performed by the network operations server 102 or the incident response tool 103 of the system 100 (see FIG. 1), or may be otherwise performed.

An incident occurs with a system or device under the control of an entity associated with the network operations server 102 at operation 402. The incident may be reported by an end user, may be noticed by a system operator or through other means. After the incident has been reported, one or more members of an escalation group are contacted at operation 404. An escalation group may be a team of individuals familiar with what other groups are most knowledgeable about the affected systems.

The escalation group will analyze the reported incident and initiate a page out process at operation 406. The process may be initiated when a page out form of the incident response tool 200 is opened. The escalation group may enter information regarding the incident or outage through the VNOC incident response tool or other tools to initiate the incident/outage process at operation 408 and transmit a page out at operation 410.

Once the page out is initiated the incident response tool creates a VNOC session at operation 412. The creation reduces manual work by reusing data entered for the page out process and provides a direct tie in from the page out process to the incident/outage and problem process.

An incident ticket is created at operation 414 based on the creation and status of the VNOC session. The incident ticket is an electronic document that contains information that records the details of the incident or outage of electronic or other support systems, such as systems that support the infrastructure facilities of an organization. For example, infrastructure facilities may include e-mail, firewalls, networking, buildings, plotting machines, wall, electricity, or the like. The support systems may also be a website, widgets, or the like.

The incident ticket typically is initially assigned to a technician that is familiar with whatever is not working. The technician may review the incident ticket to insure that it is correct. When information received from the incident response tool 200 is not correct, the technician may update the incident ticket without providing the updated information to the incident response tool 200. The incident ticket may later be used as a historical record that reflects the incident or outage and its resolution. The incident ticket may be used for producing metrics on incidents or outages.

A problem ticket may be created and updated at operation 416 based on the VNOC session. The problem ticket may be used by the technician when a workaround has been used and a root cause is understood. A problem ticket may also be created when a root cause is not understood, but known to exist. The problem ticket may direct the technician to determine and remove the true root cause of the incident or outage. The problem ticket is optionally created, depending upon whether a root cause is found or suspected.

At operation 418, one or more action tickets may be created or updated through information received from the incident response tool. The action ticket reflects the action item that is to be resolved. In some embodiments, the action ticket may be referred to as a repair ticket. For example, an action ticket may be a repair ticket when the action items are to be performed by the technician in site operations. One example of an action item is to replace a hard drive on a computing system within a time frame (e.g., two weeks). The action ticket is optionally created, depending upon whether any action items need to be performed.

In one embodiment, the creation of the corresponding incident ticket and action ticket for the incident or outage in progress based on the creation of the session creates less manual work in creating and managing forms and tickets, because the tickets can be populated with already provided incident data. Thus, the presented data may be more accurate as it comes directly from the live incident.

FIG. 4B is a flow chart describing the lifecycle of an incident within the VNOC system, according to an example embodiment. At operation 438 an incident reporter becomes aware of an incident and reports it to a VNOC operator. An incident reporter may be an individual that witnesses or becomes aware of an incident or may be an automated mechanical or electrical monitoring system that provides notification. The incident reporter may inform the VNOC operator of the incident directly or indirectly. The VNOC operator may be an escalation group or other party. Upon learning of the incident, the VNOC operator will then create a VNOC session addressing the reported incident. To create a VNOC session the VNOC operator must input basic data at operation 442, such as a description of the incident and the systems affected by the incident. In an example embodiment, the VNOC operator assigns a severity of the incident. The severity may exist on a scale, such as from 1 to 3, with 3 representing the most severe case and 1 represent the least severe case. The VNOC operator may also include additional incident detail, identify any known system owners, and create a chat room or phone bridge for the parties resolving the incident. Depending on the severity level indicated by the VNOC operator, the VNOC session may create an incident ticket. Typically, an incident ticket is always created when an incident is reported. Notifications, such as through emails or other forms of communications, may be sent out to relevant parties. Parties directly involved with the resolution of the incident may be paged.

At operation 446, the incident is managed in an ongoing fashion before it is marked as closed. During the management of the incident the VNOC operator many perform several functions to alter and update the VNOC session. The incident synopsis and impact can be updated to reflect the current status of the incident and recent changes. Additional chat sessions may be opened to deal with new issues and notifications about updates and newly discovered issues may also be sent to involved parties. As investigation of the incident continues, the VNOC operator may discover a root cause of the problem or an action that needs to be tracked and recorded. A problem ticket and/or action ticket may be spawned and associated with the VNOC session and the incident ticket. Spawned tickets may be populated with information already existing within the VNOC session. Associations between the tickets may also be created by the VNOC session. Existing incident, problem and action tickets may be edited and updated either through the VNOC session or through separate software, to reflect new status and developments.

At operation 448, if the incident or outage associated with a particular VNOC session have been closed or resolved, then that VNOC session can be closed. A closed VNOC session indicates that the incident has been resolved. A closed VNOC session and its associated data, such as chat logs, synopsis text, tickets, etc, are stored in a database and may be displayed by another VNOC session.

At operation 450, if all incident, problem and action tickets associated with an incident are closed then that incident can be closed.

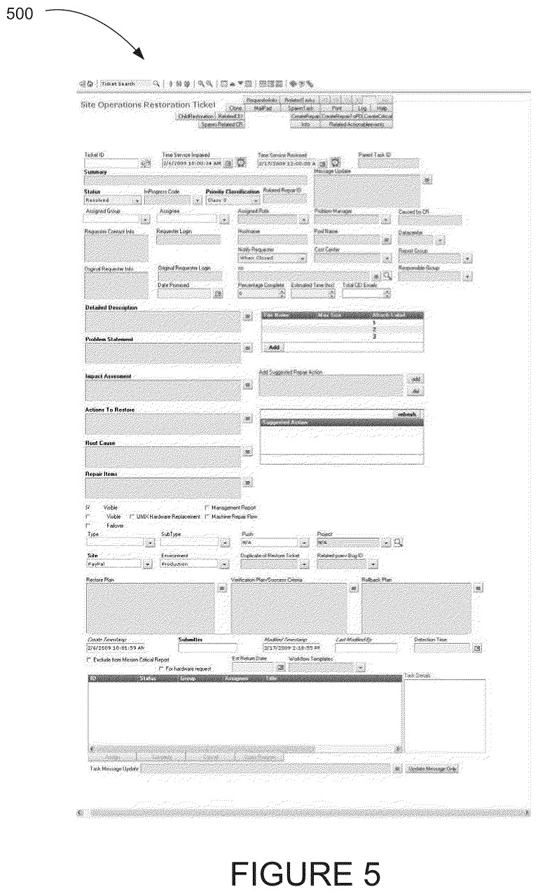

FIG. 5 is a diagram of a site operations restoration ticket 500, according to an example embodiment. A technician may complete at least some of the fields of the site operations restoration ticket 500 to document an incident or outage. The site operations restoration ticket 500 may be used by the technician to work on resolution of an active incident or outage, to report on the incident or outage, or both. For example, the site operations restoration ticket 500 may indicate what is not working and causing the incident or outage, the impact of the incident or outage, the root cause of the incident or outage, and what is being done to resolve the incident or outage.

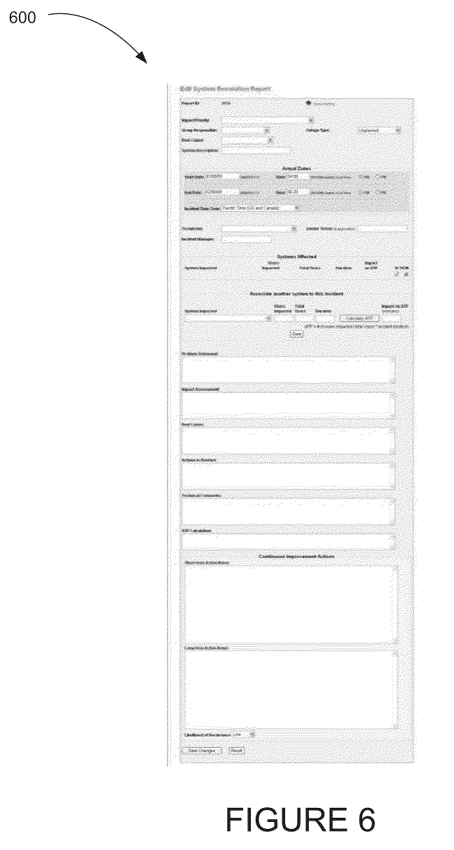

The technician may, in addition to or instead of completing portions of the site operations restoration ticket 500, complete at least some fields of a system resolution report 600. An example embodiment of the system resolution report 600 is shown in FIG. 6. The system resolution report 600 enables the technician to create a variety of reports regarding the incident. The technician may enter in notes for documentation purposes. In some embodiments, the site operations restoration ticket 500 is used by a person that is associated with site operations of an entity, while the system resolution report 600 is used by a person that associated information technology (IT) of the entity.

Without use of the incident response tool 200 or the VNOC, the incident ticket, the problem ticket and the action ticket are not automatically created. Moreover, the data entered into and/or contained within the site operations ticket 500, the system resolution report 600, or both, does not automatically flow into the incident ticket, the problem ticket, and the action ticket. Rather, the technician manually completes the fields of the incident ticket, the problem ticket, and the action ticket.

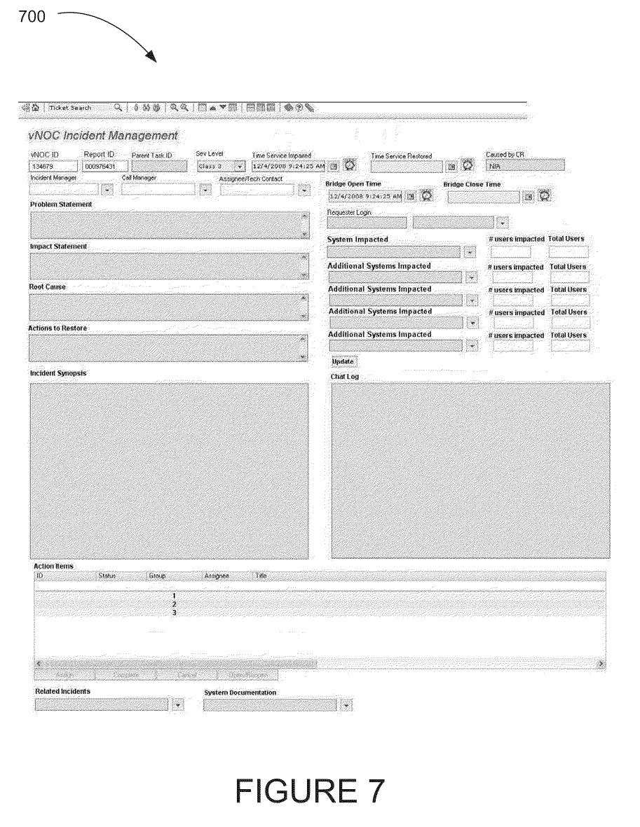

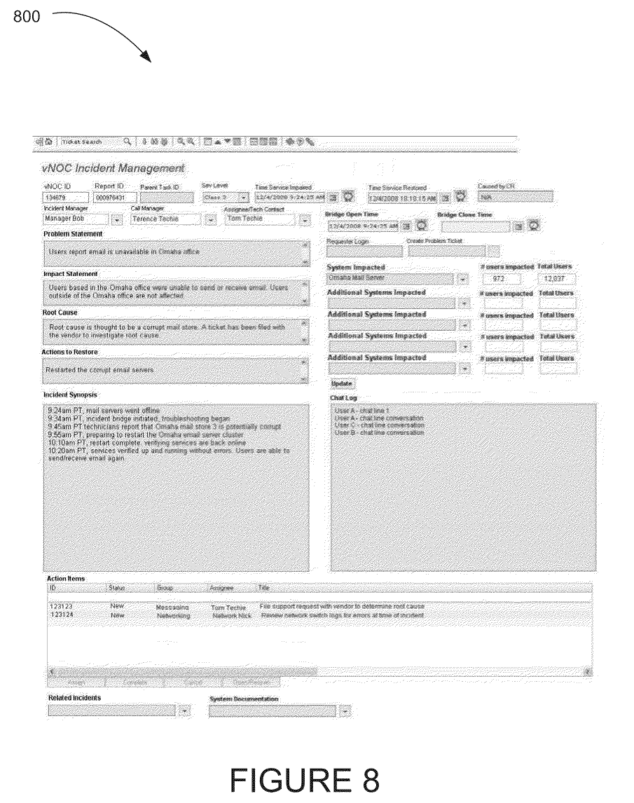

FIGS. 7 and 8 are diagrams of user interfaces 700, 800 for the incident response tool 200 (See FIG. 2), according to an example embodiment. The incident response tool 200 captures a variety of information from an incident/outage call, may automatically create the incident ticket, the problem ticket, and one or more actions tickets, and completes fields of the tickets based on data received during an incident/outage call. By automatically completing the fields, there are less manual steps to be performed by the technician and a reduced likelihood of mistakes being made or translation errors.

Example fields of the incident response tool 200 are shown in a user interface 700, while the completion of some of the fields of the user interface 700 is shown in a user interface 800. The example fields shown in the user interfaces 700, 800 include a VNOC identification field, a report identification field, a parent task identification field, a SEV level field, a time service repaired field, a time service restored field, a caused by CR field, an incident manager field, a call manager field, an assignee/tech contact field, a bridge open time field, a bridge close time field, a problem statement field, an impact statement field, a root cause field, an actions to restore field, an incident synopsis field, a requester login and password fields, a system impacted fields, an additional systems impacted fields, a chat log field, an action items table, a related incidents field, and a system documentation field. In some embodiments, one or more of the foregoing fields may be excluded from the user interfaces 700, 800. Other fields may also be included in the user interfaces 700, 800.

The VNOC identification field retains an identifier that identifies a session. The report identification field identifies a report number. The parent task identification field, when used, retains an identifier that assists with tracking items associated with the ticketing system. In one embodiment, one or more of the fields may be used to identify that a particular system is having a problem based on a number of past incidents. The past incident information may then be used to assist with the resolution of the problem.

The SEV level field retains a value that indicates the severity of the instance/outage. The SEV level is ordinarily defined by a person creating the VNOC session. The SEV level may be based on information received when the page out is performed, but may later be upgraded to a higher level or downgraded to a lower level.

The time service repaired field and the time service restored field may be manually entered or automatically generated to reflect the status of the service. The caused by CR field indicates that a change request caused the incident or outage. For example, the changes made to a firewall, a network switch or server, an e-mail server, or the like may have caused the incident or outage.

The incident manager field, the call manager field, and the assignee/tech contact field define the roles of certain people with respect to the incident or outage. Ordinarily, these people will be on an initial call to discuss the incident or outage. The bridge open time field and the bridge close time field indicate the times that the session occurred.

The problem statement field identifies the problem that is associated with the incident or outage, while the impact statement field indicates the effect or impact of the outage. For example, the problem identified in the problem statement field could be a power outage, while the impact in the impact statement field would depend on whether backup power was available. The root cause field identifies what caused the incident or outage. Some example root causes of the incident or outage include a lightning strike or a server freeze up. The actions to restore field indicates what actions will restore the impacted systems to a working condition. Some examples of actions to restore include replacing a burnt out transformer or power lines or rebooting the server that is frozen.

The incident synopsis field includes information generally includes a high level overview of what has happened, the current status, and what is being done to resolve the incident or outage. The information may also include high level status updates. The requester login field indicates a name of the person that is responsible for originally reporting the incident or outage. The system impacted fields indicates the systems that are not working, and the additional systems impacted fields indicates additional systems that are not working as a result of the systems not working. For example, the malfunctioning system may be a firewall, and the applications behind the firewall may be additional systems that are working but are inaccessible as a result of the firewall not working. The chat log field records the chat between the various collaborating parties. The action items table indicates the action items associated with the incident or outage. The related incidents field indicates the incidents or outages that are related.

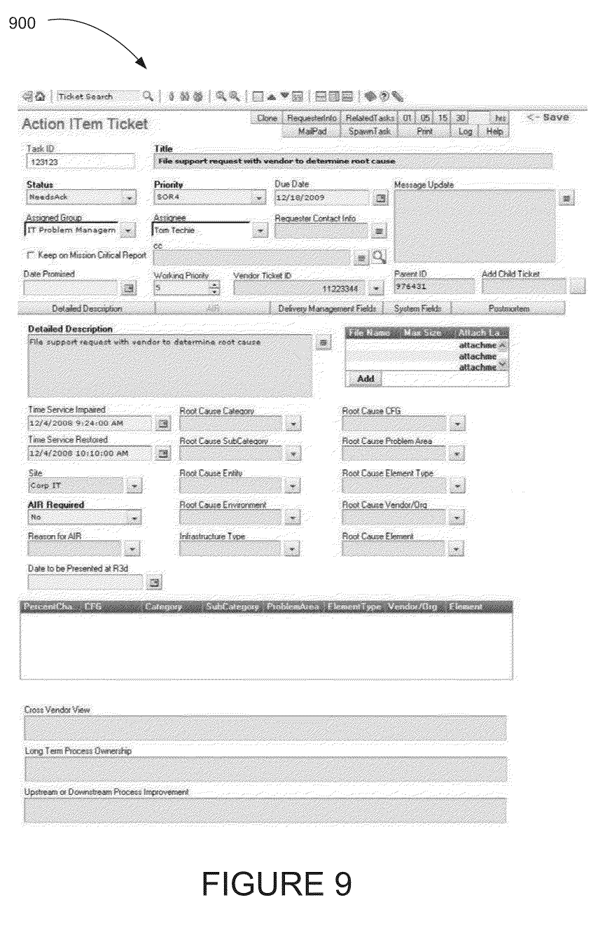

FIG. 9 is a diagram of an action ticket 900, according to an example embodiment. The action ticket 900 may be used to provide the action ticket associated with the incident or outage. At least some of the fields of the action ticket 900 are completed based on information that was entered into the user interface 800 for the incident response tool 200.

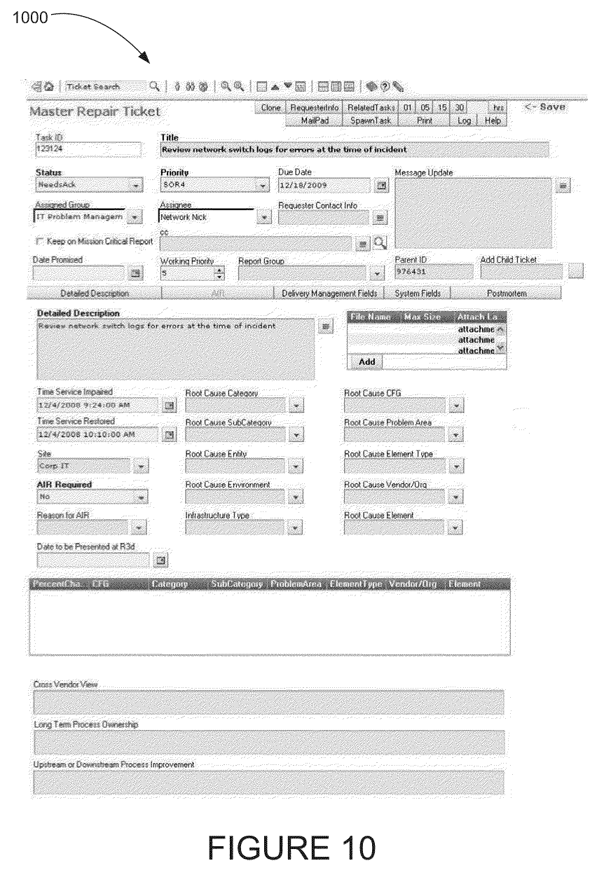

FIG. 10 is a diagram of a master repair ticket 1000, according to an example embodiment. The master repair ticket 1000 may be used to document what needs to be repaired and is associated with the incident or outage. At least some of the fields of the master ticket 1000 are automatically completed based on information that was entered into the user interface 800 for the incident response tool 200. A master repair ticket 1000 may be an instantiation of an action ticket or an action item.

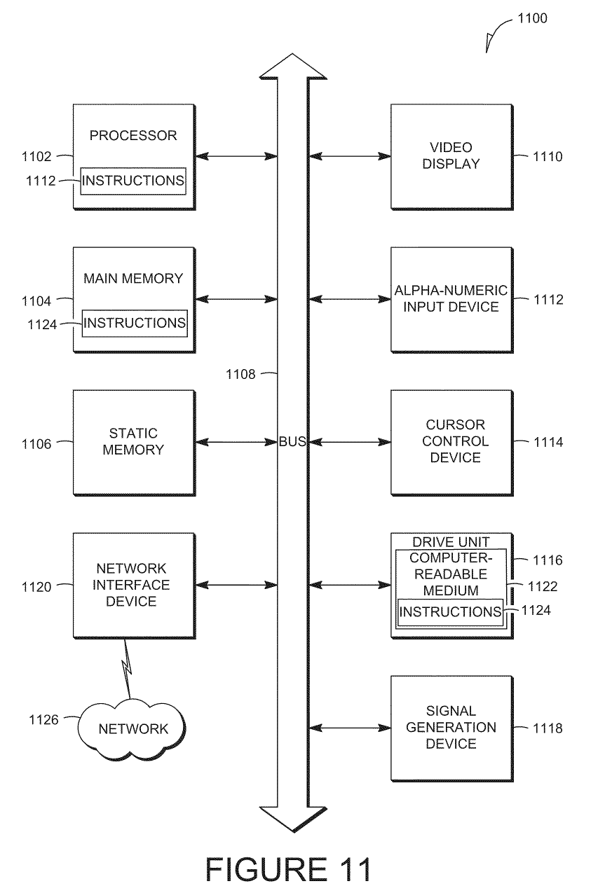

FIG. 11 shows a block diagram of a machine in the example form of a computer system 1100 within which a set of instructions may be executed causing the machine to perform any one or more of the methods, processes, operations, or methodologies discussed herein. The network operations server 102 may operate on one or more computer systems 1100. The incident user machines 106, 108 of FIG. 1 may include the functionality of the one or more computer systems 1100.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, a kiosk, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU) a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a drive unit 1116, a signal generation device 1118 (e.g., a speaker) and a network interface device 1120.

The drive unit 1116 includes a machine-readable medium 1122 on which is stored one or more sets of instructions (e.g., software 1124) embodying any one or more of the methodologies or functions described herein. The software 1124 may also reside, completely or at least partially, within the main memory 1104 and/or within the processor 1102 during execution thereof by the computer system 1100, the main memory 1104 and the processor 1102 also constituting machine-readable media.

The software 1124 may further be transmitted or received over a network 1126 via the network interface device 1120.

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the present invention. The term “machine-readable medium” shall accordingly be taken to include, but not be limited to, solid-state memories, and optical media, and magnetic media.

Certain systems, apparatus, applications or processes are described herein as including a number of modules. A module may be a unit of distinct functionality that may be presented in software, hardware, or combinations thereof. When the functionality of a module is performed in any part through software, the module includes a machine readable medium. The modules may be regarded as being communicatively coupled.

The inventive subject matter may be represented in a variety of different embodiment of which there are many possible permutations.

Thus, methods and systems for operating a virtual network operations center have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

It should be noted that the methods described herein do not have to be executed in the order described, or in any particular order. Moreover, various activities described with respect to the methods identified herein can be executed in serial or parallel fashion.

It will be understood that although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A system comprising:
a data processing module, using a processor, to receive data regarding a system incident and presenting a system synopsis and ancillary data about the system incident to a team resolving the system incident;
a collaboration module to enable collaborative text chat communication between the team; and
an incident reporting module to create an incident ticket populated with the received data regarding the system incident.

2. The system of claim 1, wherein the collaborative text chat communication is recorded for later presentation

3. The system of claim 1, wherein the collaboration module further comprises a phone bridge facilitating collaborative communication between the team.

4. The system of claim 1, further comprising a problem ticket module and an action ticket module that create a problem ticket and an action ticket, respectively, populated with the received data regarding the system incident.

5. The system of claim 4, wherein the incident reporting module, the problem ticket module, and the action ticket module further associates the incident, problem and action tickets to each other in respect to their relationships.

6. The system of claim 1, wherein data processing module presents ancillary data that comprises the data of prior incidents and their associated tickets.

7. The system of claim 1, wherein data processing module presents ancillary data that comprises data about the system affected by the incident, the teams most familiar with the system affected by the incident, and descriptions of identified problems and actions.

8. A method comprising:
receiving data regarding a system incident;
enabling, using a processor, collaborative text chat communication between a team resolving the system incident;
presenting a system synopsis and ancillary data about the system incident; and
creating an incident ticket populated with the received data regarding the system incident.

9. The method of claim 8, wherein the collaborative text chat communication is recorded for later presentation.

10. The method of claim 8, further comprising a phone bridge facilitating collaborative communication between the team.

11. The method of claim 8, further comprising creating a problem ticket and action ticket populated with the received data regarding the system incident.

12. The method of claim 11, further comprising associating the incident, problem and action tickets to reflect the relationships between the incident ticket, problem, and action tickets.

13. The method of claim 8, wherein the ancillary data comprises the data of prior incidents and their associated tickets.

14. The method of claim 8, wherein the ancillary data comprises data about the system affected by the incident, the teams most familiar with the system affected by the incident, and descriptions of identified problems and actions.

15. A machine-readable medium comprising instructions, which when implemented by one or more processors perform the operations comprising:
receiving data regarding a system incident;
enabling, using a processor, collaborative text chat communication between a team resolving the system incident;
presenting a system synopsis and ancillary data about the system incident; and
creating an incident ticket populated with the received data regarding the system incident.

16. A machine-readable medium as in claim 15, wherein the collaborative text chat communication is recorded for later presentation.

17. A machine-readable medium as in claim 15, further comprising the operation of creating a problem ticket and action ticket populated with the received data regarding the system incident.

18. A machine-readable medium as in claim 18, further comprising the operation of associating the incident, problem and action tickets to reflect the relationships between the incident ticket, problem, and action tickets.

19. A machine-readable medium as in claim 15, wherein the ancillary data comprises the data of prior incidents and their associated tickets.

20. A machine-readable medium as in claim 15, wherein the ancillary data comprises data about the system affected by the incident, the teams most familiar with the system affected by the incident, and descriptions of identified problems and actions.
